(19) United States
(12) Patent Application Publication
(10) Pub. No.: US 2003/0009532 A1
(43) Pub. Date: Jan. 9, 2003

(54) Multiprocessor system having a shared main memory

(76) Inventor: Gerhard Otte, Wolfratshausen (DE)

Correspondence Address: Morrison & Foerster LLP, Suite 300, 1650 Tysons Boulevard, McLean, VA, 22102, US

(21) Appl. No.: 10/166,033

(22) Filed: Jun. 11, 2002

(30) Foreign Application Priority Data
Jun. 12, 2001 (DE) 10128475.6

(51) Int. Cl. G06F 15/167

(52) U.S. Cl. 709/213; 709/214

(57) ABSTRACT

A multiprocessor system has a plurality of processor units for handling data for a joint process in a shared main memory SM. Each processor unit has a local main memory. The processor units use a peripheral bus system, preferably a PCI bus system, to access the shared main memory implemented by the local main memory for a priority processor unit.

This application claims priority to German application 10128475.6 filed Jun. 12, 2001, the contents of which are hereby incorporated by reference.

### TECHNICAL FIELD OF THE INVENTION

The invention relates to a multiprocessor system for the joint handling of a process by a plurality of processor units, and in particular, to a system where the data for the joint process are processed in a shared main memory which is accessed by the processor units involved in the process.

### BACKGROUND OF THE INVENTION

In a multiprocessor system, a plurality of processors co-operate. This allows the system's processing power to be increased, because the joint use of a plurality of processors operating in parallel allows a higher data throughput to be achieved than with a single processor of the same type. Most algorithms and processes handled by digital computers can also be handled in parallel. Since the processor speed, which is dependent on the clock frequency and on the number of bits handled at the same time, can be increased above a particular value only with considerable financial expenditure, it makes more economic sense to have processes processed by a plurality of slower processors operating in parallel. Some of the advantages attained on the basis of parallel use of a plurality of processors are paid for in drawbacks such as lower system reliability or greater programming complexity, however. Such drawbacks can usually be attributed to the hierarchic organization of the individual processors.

Multiprocessor systems are normally coupled in one of two ways, namely are loosely coupled or are tightly coupled.

In loosely coupled multiprocessor systems, each processor has its own associated main memory, its own input/output units and a separate operating system. The processors communicate via shared connections in the form of local area networks or cluster networks. By way of example, U.S. Pat. No. 5,036,459 describes such a multiprocessor system having a distributed memory. In such systems, flexibility and performance are limited by the speed of the switching matrix. In addition, a plurality of processors are not able to handle the same task efficiently without transferring enormous volumes of data and volumes of information.

In tightly coupled multiprocessor systems, a few processors access a shared large main memory. These processors are arranged physically close to one another and use a common memory bus, common input/output devices and a common operating system. All the processors and processes share access to the common main memory, to the network interfaces, input/output devices and to the mass memory. In such a system, any processor can be used for any process at any time. Such multiprocessor systems require a very fast memory bus and a reliable arbitration device in order to ensure, by means of fair arbitration of memory access, that no processor unit is refused access with long-lasting effect.

U.S. Pat. No. 5,067,071 discloses a multiprocessor system in which a multiplicity of processor units, each comprising two processors and a cache for buffer-storing data which are frequently required locally, use a common system bus to access a shared large main memory. The system bus, containing a data bus, a vector bus, an address bus and a control bus, is controlled by means of a system controller with a bus arbiter.

U.S. Pat. No. 4,214,305 describes a multiprocessor system in which a plurality of processors each have an associated main memory, and these processors can respectively use a bus arbiter and a common system bus to access a shared main memory. In this context, the bus arbiter ensures that only one processor can ever access the common system bus at any time.

U.S. Pat. No. 4,414,624 likewise describes such a system, where each processor has an associated task manager for the joint process, and the joint process is controlled by a system state control computer. This system state control computer uses the system bus to access the shared memory under the control of an arbiter module, like the other processors.

A bus arbiter and its manner of operation are described in U.S. Pat. No. 4,229,791, for example.

U.S. Pat. No. 5,884,027 describes a tightly coupled multiprocessor system having a PCI bus and having a crossover device, called a PCI/PCI bridge, for connecting a plurality of PCI bus segments. The term bridge is normally used for a unit for permitting data traffic between network units on the basis of DLL information. DLL stands for Data Link Layer and corresponds to layer 2 of the OSI 7-layer model. This layer 2 is split into a top sublayer Logical Link Control LLC and a bottom sublayer Media Access Control MAC.

A PCI/PCI bridge splits a PCI bus system into a segment which is concerned with the host processor and host memory and is called the primary PCI bus, and into a segment which is concerned with PCI peripheral units and is called the secondary PCI bus.

PCI is an abbreviation for the term Peripheral Component Interconnect, and a PCI bus is a standardized local bus for connecting peripheral units to a personal computer. From a technical point of view, a PCI bus is not a bus, but rather a bridge function with buffer stores for decoupling the “fast” processor side from a “slower” peripheral side. The PCI bus thus permits asynchronous operation of peripheral units and processor with main memory. In this context, peripheral units denote any part of a computer apart from the processor and the main memory, for example disk drive, keyboard unit, mouse, monitor, printer, scanner, microphone, loudspeaker, camera, video card, modem or network card.

A PCI bus or PCI system comprises three fundamental groups of components:

the line system with the PCI slots for coupling PCI peripheral components;

the primary card chipset for implementing the coupling components north bridge and south bridge; and

PCI bridges for controlling interaction between the operating system and PCI components. PCI bridges can, by way of example, be PCI/EISA bridges for connecting an EISA bus, PCI/SCSI bridges for connecting SCSI components, or PCI/PCI bridges for extending the PCI system.

The north bridge is normally an integrated circuit which connects a processor unit and its system memory via a host bus to PCI buses, and optionally to a graphics port (ACCELERATED GRAPHICS PORT AGP). The south bridge is normally an integrated circuit for controlling IDE bus, universal serial bus USB, PLUG-and-PLAY functionality, PCI/EISA bridge, keyboard/mouse control unit, power management and many other features.

One preferable form for an extension of a PCI bus system by means of PCI/PCI bridges is described in U.S. Pat. No. 6,189,063 B1, for example.

The way in which the PCI information flow control works in PCI bus systems having a plurality of PCI/PCI bridges is described in U.S. Pat. No. 5,878,237, particularly in conjunction with FIGS. 4, 4A, 5, 5A and 5B and the associated description in columns 17 to 20. The PCI information flow control described therein comprises the units PCI-ADDRESS comparator, PCI-Target-Flow-Controller and PCI-Arbiter and serves to prevent access collisions and also to control ordered PCI bus access for all the connected components.

U.S. Pat. No. 5,828,865 describes, particularly with reference to FIGS. 2 and 3 in columns 4 and 5, a tightly coupled multiprocessor system in which a multiplicity of processors forming a processor unit are connected to one another and access a host bus which can be connected to further processor units by using a cluster control unit “Cluster Attachment”. This host bus is connected to up to four PCI bus segments via a special PCI/host bridge system. In this context, a bridge control unit and two expansion units adopt the function of a special south bridge.

The loosely coupled multiprocessor systems described above have the common feature that access to a shared memory for the processors takes longer than access to their locally assigned main memory or cache. Such systems are consequently more suitable when relatively large volumes of data do not need to be transferred between the individual processor units and the shared memory all too often. For coupling a processor unit with a high frequency of access to the shared memory, that is to say a processor unit which performs many single operations in the shared memory, a known loosely coupled multiprocessor system is less suitable.

### SUMMARY OF THE INVENTION

The invention discloses a multiprocessor system which allows for the connection of a processor system with a high frequency of access to a shared memory and for the connection of a processor system with a high data volume transfer requirement to this shared memory.

In one embodiment of the invention, there is a multiprocessor system in which at least one processor unit is given priority such that the shared memory is implemented in the processor unit's locally assigned main memory. In this context, the local main memory for the priority processor unit is preferably configured such that the remainder of the processor units can access part of the main memory. According to the invention, the processor systems involved are connected by a peripheral bus system in order to allow the non-priority processor units to access the shared memory in the main memory for the priority processor unit.

Implementing the shared memory in the main memory for one of the processor units allows the priority processor unit to access this shared memory at high speed. The reason for this is that this processor unit accesses the shared memory via the processor's memory bus, for example a front-side bus with a clock frequency of 133 MHz. This means that the connection between the shared memory and this priority processor unit is optimized for high frequency of access and for access operations with small volumes of data.

The non-priority processor units use, for example, a peripheral bus system to access the shared memory and are therefore optimized more in terms of less frequent memory access operations with larger volumes of data.

In another embodiment of the invention, the processor units are connected to one another directly by a PCI bus system. Such a PCI bus system is very simple and inexpensive to produce. More recent PCI buses with a bus width of up to 64 bits and a clock frequency of up to 66 MHz are also fast enough to transfer larger volumes of data. In addition, standardized bulk components undertake the functions of the bus system, such as north bridge, south bridge, PCI slots, PCI/PCI bridge, etc. A PCI bus system is very simple to configure and is initialized automatically when the operating system is started. In contrast to the known multiprocessor systems described in the introduction, which use a PCI bus only for connecting peripheral devices or as an interposed bus unit between a processor unit and an Ethernet bus, the processor units in this case are connected directly by a PCI bus system.

In another embodiment of the invention, a non-priority processor unit preferably accesses the shared memory via a PCI/PCI bridge, the primary PCI bus of the priority processor unit and a PCI north bridge for this priority processor unit. This allows, by way of example, each PCI/PCI bridge to be used as a buffer store for the respectively connected processor unit. If appropriate, the PCI/PCI bridges can also be configured by the priority processor unit, as described in U.S. Pat. No. 6,189,063 B1. By connecting the rest of the processor units to the primary PCI bus of the priority processor unit, the priority processor unit or its primary PCI bus can undertake the management of access to the shared memory.

A processor unit within the context of the present invention can be both a single processor and an arrangement comprising a plurality of tightly coupled processors which have a single main memory and a single operating system. In this context, a system optimized for an instance of application can use a tightly coupled multiprocessor arrangement as a priority processor unit as required or else as one or more of the non-priority processor units as required.

For joint processing of a process, to provide a plurality of processor units having a high frequency of access to the shared memory, one emboidment of the invention allows the shared memory to be distributed over two or possibly more main memories for individual processor units as well. This can be achieved by virtue of the processor units involved in a process being able to use the PCI bus system to access the local main memories for at least two processor units. To this end, the bridges (PCI/PCI bridge or north bridge) for the main memories to which general access needs to be possible need to be configured both as “masters” and as “targets”. If the common main memory is arranged distributed in this way, the same data should not be stored at a plurality of locations in the common memory at the same time, in order to avoid complex synchronization of the individual parts of the common memory.

### BRIEF DESCRIPTION OF THE DRAWINGS

The invention is explained in more detail below using an exemplary embodiment with reference to the drawing, in which:

FIG. 1 shows an exemplary embodiment of a multiprocessor system in accordance with the invention.

### DETAILED DESCRIPTION OF THE PREFERRED EMBODIMENTS

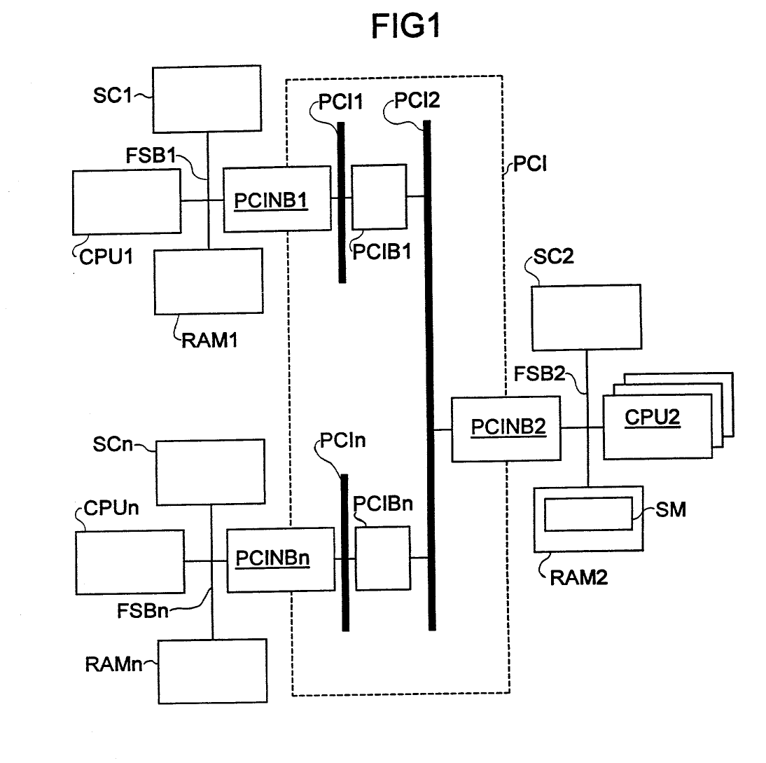

The multiprocessor system shown in FIG. 1 has three processor units CPU1, CPU2, CPUn coupled by a PCI bus system PCI. Each of the processor units CPU1, CPU2, CPUn has a locally assigned cache SC1, SC2, SCn and a locally assigned main memory RAM1, RAM2, RAMn. Each processor unit CPU1, CPU2, CPUn is connected to its main memory RAM1, RAM2, RAMn, to its cache SC1, SC2, SCn and to an associated PCI north bridge PCINB1, PCINB2, PCINBn by a respective local memory bus FSB1, FSB2, FSBn. Such a local memory bus can, by way of example, be a standardized front-side bus with a clock frequency of 133 MHz.

The aforementioned PCI north bridges PCINB1, PCINB2, PCINBn respectively form a primary PCI bus PCI1, PCI2, PCIn with conductor arrangements and PCI slots and possibly with a south bridge (not shown) for the connected processor unit CPU1, CPU2, CPUn.

In the exemplary embodiment shown in FIG. 1, the main memory RAM2 includes a shared memory area SM which can be accessed by the processor units CPU1, CPU2, CPUn. Accordingly, the processor unit CPU2 is a priority processor unit on the basis of the invention.

The primary PCI bus PCI2 of the priority processor unit CPU2 is connected to the primary PCI bus PCI1 of the first processor unit CPU1 via a first PCI/PCI bridge PCIB1, and is connected to the primary PCI bus of the further processor unit CPUn via a further PCI/PCI bridge PCIBn.

Accordingly, the primary PCI buses PCI1, PCI2 and PCIn of the individual processor units CPU1, CPU2, CPUn form a PCI bus system PCI with the PCI bridges PCIB1, PCIBn, with the primary PCI buses PCI1, PCIn of the first processor unit CPU1 and of the further processor unit CPUn respectively being secondary PCI bus segments from the point of view of the priority processor unit CPU2.

To ensure read access and write access to the shared memory SM by the first processor unit CPU1 and by the further processor unit CPUn, the north bridge PCINB2 for the priority processor unit CPU2 is configured both as a “master” and as a “target” in the exemplary embodiment shown. Since no provision is made for other processor units to access the main memory RAM1 for the first processor unit CPU1 or the main memory RAMn for the further processor unit CPUn, it is sufficient to configure the PCI/PCI bridge PCIB1 and the PCI/PCI bridge PCIBn as “masters” and not as “targets”.

If the multiprocessor system shown in FIG. 1 is intended for joint processing of a process whose process data are managed in the shared memory SM, the PCI target functionality of the north bridge PCINB2 allows memory access to the shared memory SM by the external bus users CPU1 and CPUn. The PCI bus arbiter provided in each PCI bus undertakes the arbitration function for the shared memory SM. In addition, no separate memory needs to be physically provided as a shared memory.

If, in a process which is to be processed, the priority processor unit CPU2 has the task of performing a large number of bit operations, that is memory access to small data blocks, then the processor unit CPU2 benefits from direct access to the shared memory in its own main memory RAM2. In addition, the priority processor unit CPU2 can make optimum use of its cache SC2 in such a process, since the cache SC2 also has priority connection to the shared memory SM via the memory bus FSB2. For process sequences with a high frequency of memory access, this arrangement can consequently be used in optimum fashion.

For the rest of the processor units CPU1, CPUn involved in the process, the situation described is optimized for memory access operations to the shared memory SM with large volumes of data. The use of a peripheral bus system with a high transfer capacity, such as a PCI bus, for connecting these non-priority processor units CPU1, CPUn to the shared memory SM permits large volumes of data to be transfered with few single access operations.

What is claimed is:

1. A multiprocessor system for handling of a process by at least two processor units, comprising:
a shared main memory, which can be accessed by the processor units, for processing data, each processor unit having a local main memory; and
a common bus system enabling the processor units to access the shared main memory, wherein the shared main memory is implemented by the local main memory for a priority processor unit, and
the processor units are connected by a peripheral bus system to allow non-priority processor units to access the shared memory in the main memory for the priority processor unit.

2. The multiprocessor system as claimed in claim 1, wherein the peripheral bus system is a PCI bus system.

3. The multiprocessor system as claimed in claim 2, wherein the non-priority processor unit accesses the shared memory via at least one of a PCI bridge, the primary PCI bus of the priority processor unit and a PCI north bridge for the priority processor unit.

4. The multiprocessor system as claimed in claim 1, wherein at least one processor unit is implemented by a plurality of coupled processors.

5. The multiprocessor system as claimed in claim 1, wherein the processor units are configured to use the peripheral bus system to access the local main memory for at least two processor units.
